(19) United States
(12) Patent Application Publication
(10) Pub. No.: US 2010/0020440 A1
(43) Pub. Date: Jan. 28, 2010

(54) LOW PROFILE SUBSTRATE SHIPPER

(75) Inventor: John E. Stasieluk, Edina, MN (US)

Correspondence Address: Shumaker & Sieffert, P.A., 1625 Radio Drive, Suite 300, Woodbury, MN, 55125, US

(73) Assignee: Seagate Technology LLC, Scotts Valley, CA (US)

(21) Appl. No.: 12/179,714

(22) Filed: Jul. 25, 2008

(51) Int. Cl. G11B 23/03

(52) U.S. Cl. 360/133; G9B/23.02

(57) ABSTRACT

A container for transporting media that includes a body with a top opening and a bottom opening, and a top lid to cover the top opening and a bottom cover to cover the bottom opening. The body includes a disk separator comb with rails to hold media disks. The rails are shaped such that they follow part of the contour of a circle. The height of the body is such that the circle projects out of the top opening.

### BACKGROUND

Thin film magnetic recording disks or other media disks are typically very sensitive and delicate. Consequently, the entire surface of both sides of media disks are covered with high density magnetic or optical elements used for storing data. As the data density increases, the delicacy and sensitivity of the disks also increases.

A longitudinal recording medium typically comprises a non-magnetic substrate having sequentially deposited on each side thereof an underlayer, such as chromium (Cr) or Cr-alloy, a magnetic layer, typically comprising a cobalt (Co)-base alloy, and a protective overcoat, typically containing carbon. Conventional practices also comprise bonding a lubricant topcoat (not shown) to the protective overcoat. Underlayer, magnetic layer, and protective overcoat, are typically deposited by sputtering techniques. The Co-base alloy magnetic layer deposited by conventional techniques normally comprises polycrystallites epitaxially grown on the polycrystal Cr or Cr-alloy underlayer.

A conventional perpendicular recording disk medium, is similar to the longitudinal recording medium described above, but with the following differences. First, a conventional perpendicular recording disk medium has soft magnetic underlayer of an alloy such as Permalloy instead of a Cr-containing underlayer. Second, a magnetic layer of the perpendicular recording disk medium comprises domains oriented in a direction perpendicular to the plane of the substrate.

As described above, both the longitudinal and perpendicular recording disks include multiple layers on a substrate. Each of these layers are vital to the performance of the disk. The smallest scratch on the disk's surface or any of the layers under the top layer can result in unacceptable failure of the disk operation. Accordingly, it is very important that the disks be carefully transported, both during and after their manufacture. It is also important that the media disks are not damaged or scratched as they are placed in the transport containers. To reduce the possibility of damage to the disks during their manufacture and transport, most of the operation of manufacturing machinery and transporting are automated.

For the foregoing reasons, media disk transport containers have been developed that are made of a non-abrasive material and are uniform throughout the industry to allow their use in automated machinery. However, these containers are expensive to manufacture. Both the materials used to make the containers, as well as the processes used to make them are expensive. Conventional containers include a main body that surrounds the entire media disks as well as covers that enclose the main body. Accordingly, the containers include two layers of the expensive material required for the transport of media disks.

Aside from scratches and abrasion, magnetic media disks can also be damaged by electrical pulses or shocks. Relatively small amounts of static discharge, such as those that causes a spark when a person touches a metal doorknob, are large enough to destroy an entire box of magnetic media disks. Thus, it is desirable to protect the disks from these static discharges.

Thus, there is a need for a media disk container that is inexpensive to manufacture and uses fewer expensive materials. There is also a need for a media disk container that protects the disks from electrostatic discharge (ESD). It is also desirable that such a media disk container addressing these needs be designed to cooperate with existing automated machinery.

### SUMMARY OF THE INVENTION

An embodiment of the invention relates to a container for transporting disks comprising a body adapted to hold a plurality of disks comprising a top opening, a bottom opening and a disk separator comb within the body, the disk separator comb including a plurality of rails operable to hold a peripheral edge of the disks, each rail being shaped to follow the contour of a section of a circle, wherein a portion of the circle extends outside the body; a concave lid that is attached to the body, covers the top opening, and contains the portion of the circle extending outside the body; and a base cover attached to the body and covering the bottom opening.

These and various other features and advantages will be apparent from a reading of the following detailed description. As will be realized, this invention is capable of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

FIG. 1 is a perspective view of an embodiment of the body of the container;

FIG. 1a is detailed view of an embodiment of disk separator rails;

FIG. 2 is a perspective view of an embodiment of the concave lid of the container;

FIG. 3 is a perspective view of an embodiment of the base cover; and

FIG. 4 is a cross-sectional view of the embodiment shown in FIG. 1.

### DETAILED DESCRIPTION

The invention relates to a container for secure storage of disk type products during shipping. The embodiments of the invention relate to a media shipper that has a low profile design and is economical and for disks, such as thin film magnetic recording disks.

In one embodiment, the invention provides a container for transporting media disks that includes a body adapted to hold a plurality of media disks. The body includes a top opening and a bottom opening. Inside the body is a disk separator comb that includes rails, which are operable to hold the disk separator comb. Each rail is shaped to follow the contour of a section of a circle. The body of the container is designed such that the circle extends out of the top opening. The container also includes a top lid that attaches to the body over the top opening and a bottom cover that attaches over the bottom opening.

In another embodiment, the invention provides a method of making a container for transporting media disks. The method includes form a body that includes a top opening and a bottom opening. The body also includes a disk separator comb within the body, the disk separator comb including a plurality of rails operable to hold the peripheral edge of the media disks. Each rail in the disk separator comb is shaped to follow the contour of a section of a circle, wherein a portion of the circle extends outside the body. The method also includes forming a concave lid operable to cover the top opening, and contain the portion of the circle extending outside the body. Also included in the method is forming a base cover operable to cover the bottom opening.

The invention provides a container for the transport of disks, such as media disks or their substrates. The container of the present invention is particularly advantageous for media disks, which are more delicate than the substrates which are used for the media disks. However, the substrates have substantially the same geometry as the media disks, and it is also advantageous to carry the substrates using the present invention. For convenience, the remaining description will refer only to media disks. However, it is to be understood the invention may be used interchangeably with media disks and substrates.

The container includes a body 2 that supports the media disks. The body 2 has an open top 4 and an open bottom 6. The body 2 is adapted to hold a plurality of circular media disks, each of which may include a hole therethrough at its center. A disk separator comb 8 that is designed to hold each of the plurality of media disks on its edge is included in the body 2. The base 10 of the body 2 is narrower than an upper portion 12. The base 10 is constructed to fit the existing automation machinery for use with conventional media disk carriers. For example, the narrower base 10 allows for the container to ride along rails in the automation machinery so that the container is supported with in the rails.

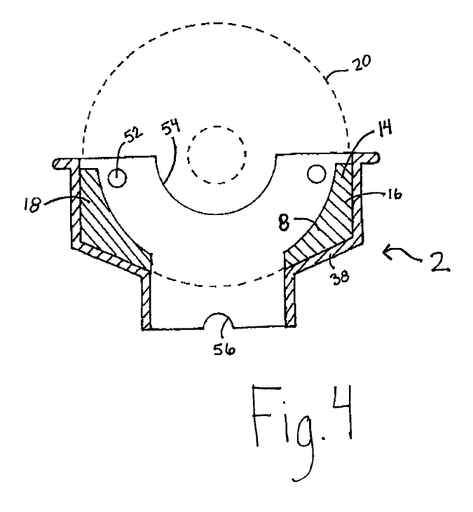

The disk separator comb 8 of the body 2 holds the media disks and keeps them separated a predetermined distance, such that they do not interfere with one another and can be easily removed from the container. The disk separator comb 8 includes a plurality of rails 14 that are adapted to hold the media disks. The rails 14 follow the contour of a circle 20 (shown in FIG. 4) corresponding the circumference of the media disks. For example, the rails 14 follow the contour of a circle 20 that is slightly larger than the outer circumference of the media disks. The rails 14 may be formed in sections 16, 18, (shown in FIG. 4) where each section holds a portion of the edge of the media disk. In a simple embodiment, a first section 16 is included in the comb separator 8 on one side of the open bottom 6, and a second section 18 is included in the comb separator 8 on the other side of the open bottom 6. More complicated embodiments may include many sections that make up the rail. Regardless of the number, each section follows the contour of the circle 20 where the edge of the media disk is held. The body 2 is constructed with a height that allows the media disks to extend out of the top opening 4. Consequently, the circle 20 which the rails 14 follow also extends out of the top opening 4 of the body 2. As a result, the height of the body 2 is short, and the body 2 of the container requires less material than conventional containers. As discussed below, this provides a substantial advantage.

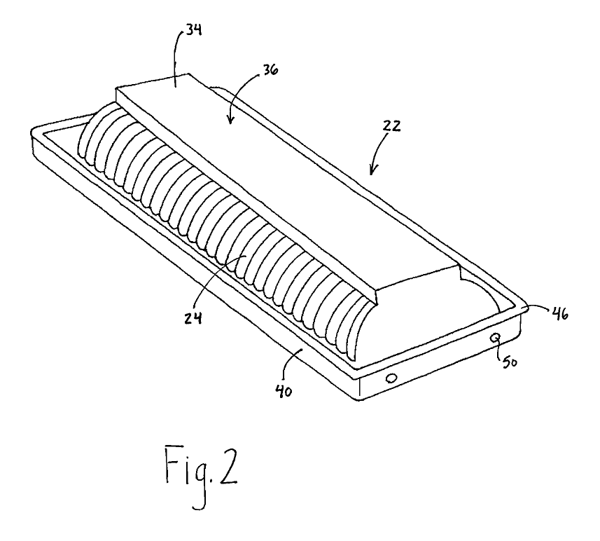

In addition to the body 2, the container also includes a concave lid 22 that covers the top opening 4, as shown in FIG. 2. The tops of the media disks that extend out of the body 2 of the container are covered by concave lid 22. The tops of the media disks sit within a concave area in the lid 22. One or more portion 24 of the concave lid 22 may follow the contour of the media disks and the circle 20. Further, the lid 22 may include guide elements 24, similar to rails 14 that hold the media disks in place.

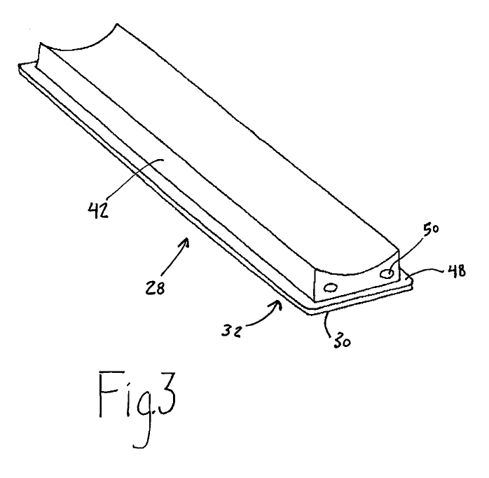

Opposite the concave lid 22, the container also includes a base cover 28 that closes the bottom opening 6 of the body 2, as shown in FIG. 3. The base cover 28 can telescopically fit into the bottom opening 6 and snuggly seal the opening 6 shut. The outer surface 30 of the base cover 28 can include a channel 32 thereon. In other words, an indented channel 32 projects upward from the bottom of the base cover 28. The concave lid 22 can include a projection 34 on its upper surface 36; the size of the projection 34 corresponds to the size of the channel 32 in the base cover 28. As a result, the base cover 28 may be stacked on top of the concave lid 22. Thus, the completed containers 1 are stackable.

In order to prevent damage to the media disks from static electricity, the container may be conductive enough to allow electric charge to dissipate therethrough. In other words, the material may provide electrostatic discharge protection. Additionally, a conductive path may be provided between the concave lid 22, the body 2 and the base cover 28. Preferably, the material used for the container is dissipative, for example, having a surface resistivity between 10⁵-10⁷ ohm/square. In order for the material to be dissipative it may include carbon. One example of a dissipative material that may be used is polycarbonate with carbon additives. Parts of the body 2, the concave lid 22 and the base cover 28 can be made polycarbonate with carbon additives. In a preferred embodiment, the concave lid 22 and base cover 28 can be molded entirely of a single dissipative material. Both the concave lid 22 and the base cover 28 can be designed such that they may be thermoformed. As a result, the production of the concave lid 22 and base cover 28 can be relatively inexpensive.

Because the comb separator 8 comes in direct contact with the media disks, it may be desirable to make it out of a different material than the rest of the container. Accordingly, the comb separator 8 can have properties that are ideal for holding the media disks. For example, the body 2 can be made out of one material, while the concave lid 22 and base cover 28 are made of another. An ideal material for the comb separator is carbon loaded polyetheretherketone (PEEK), which is both abrasion resistant and provides electrostatic discharge protection. PEEK is a relatively expensive material, and it is therefore advantageous to limit its use in the container. One method of reducing the amount of PEEK is by having the body 2 formed of the comb separator 8 and a separate outer shell 38 which makes up the rest of the body.

If the body 2 is formed of a comb separator 8 that is a separate material or piece than the outer shell 38, the comb separator 8 may be detachable from the outer shell 38. Accordingly, the comb separator 8 can be switched out of the container and replaced with a comb separator 8 that is designed for media disks of a different diameter. The detachable comb separator 8 can snap fit into the outer shell 38, or it may be clipped into the outer shell 38 using fasteners (not shown). In another embodiment, the comb separator 8 and outer shell 38 can be formed in a two shot molding process. The comb separator 8 can be molded in a first step and the outer shell 38 can then be overmolded around the comb separator 8 in a second step. In one embodiment the comb separator 8 is made of PEEK, while the outer shell 38 is made of polycarbonate with carbon additives.

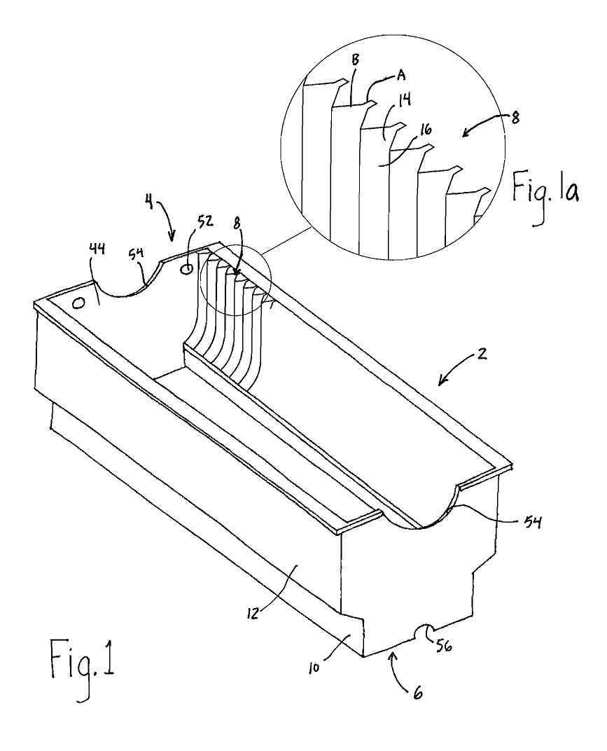

The rails 14 of comb separator 8 can include compound bevels A and B, as shown in FIG. 1. The angle of B is greater than that of A, allowing angle B of the rail 14 to help guide the media disk into the comb separator 8 to reduce the risk of contact in the sensitive and delicate media surface. The smaller angle A of the rail 14 ensures that the media disk is secured in the comb separator 8 properly.

In one embodiment of the invention, the concave lid 22 and the base cover 28 fight snuggly into the body 2. This design has two advantages. First, the container does not require clips or latches to hold the concave lid 22 or the base cover 28 in place. Second, by having the concave lid 22 and base cover 28 snuggly fit into the body 2, a conductive path is guaranteed between the three components of the container. In the shown embodiment, each of the concave lid 22 and the base cover 28 have an outer surface 40, 42 respectively, that interface with the inner surface 44 of the body 2. Having the concave lid 22 and the base cover 28 fit inside the body 2, allows the outer side dimensions of the container to be defined by the body 2. To prevent the concave lid 22 from being inserted too far into the body 2 and destroying the media disks, it can include a top flange 46 that defines a limit to the distance top lid 22 can be inserted into body 2. Similarly, base cover 28 can include a bottom flange 48 to prevent the base cover 28 from being inserted too far into body 2. Detents 50 may be provided in the outer surface 40, 42 of the concave lid 22 or base cover 28 with corresponding domed bumps 52 on the inner surface 44 of the body 2. The swells 52 fit within detents 50 when the concave lid 22 or base cover 28 are inserted in the body 2 to help secure the connection therebetween. Alternatively, the domed bumps 52 may be provided on the concave lid 22 or base cover 28 with the detents 50 on the body.

The container is designed so that the media disks can be easily removed from inside. For example, the disk separator comb 8 keeps the disks separated at equal spacing so that automated machinery can reach into the container and remove a disk. The body 2 of the container can also include a cutout 54 in one or each of its side walls, as shown. The cutout 54 is aligned with the center hole of all the media disks. Consequently, a single arm can pass through all the plurality of media disks from one side of the container and remove all of the disks at once. To further aid in automation processes using the container, one or each end of the body may include a notch 56 that operates as an alignment marker.

The present invention includes a smaller injection molded body than conventional media disk containers. As a result, production costs are reduced. Further, the concave lid 22 and base cover 28 can be designed with a shape that is ideal for thermoforming. This method of manufacturing is also less expensive than those used for conventional containers, further reducing costs. Thus, the container of the present invention is an ideal, low cost media disk container.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

As shown, the present invention advantageously provides, as by an apparatus and accompanying processing techniques which can be reliably practiced at low cost, improved methodologies and instrumentalities for forming disks to yield substrates with reliable inner and outer dimensions facilitating their use as substrates for high aerial density thin film magnetic and/or MO recording media.

In the previous description, numerous specific details are set forth, such as specific materials, structures, reactants, processes, etc., in order to provide a better understanding of the present invention. However, the present invention can be practiced without resorting to the details specifically set forth. In other instances, well-known processing materials and technique s have not been described in detail in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein. The implementations described above and other implementations are within the scope of the following claims.

We claim:

1. A container for transporting disks comprising:
a body adapted to hold a plurality of disks comprising a top opening, a bottom opening and a disk separator comb within the body, the disk separator comb including a plurality of rails operable to hold a peripheral edge of the disks, each rail being shaped to follow the contour of a section of a circle, wherein a portion of the circle extends outside the body;
a concave lid that is attached to the body, covers the top opening, and contains the portion of the circle extending outside the body; and
a base cover attached to the body and covering the bottom opening.

2. The container of claim 1 wherein the body comprises a dissipative material having a surface resistivity between 10⁵ to 10⁷ ohm/square.

3. The container of claim 2 wherein the concave lid and the base cover each comprise a dissipative material having a surface resistivity between 10⁵ to 10⁷ ohm/square.

4. The container of claim 1 wherein an outer surface or the concave lid includes a projection,
an outer surface of the base cover includes a channel that corresponds with the projection, and
the projection is operable to fit within the channel such that the containers are stackable.

5. The holder of claim 1 wherein part of the concave lid follows the contour of the portion of the circle that extends out of the body.

6. The holder of claim 1 wherein the concave lid includes an outer surface that telescopically fits inside the top opening of the body.

7. The holder of claim 6 wherein the outer surface includes detents and an inner surface of the body includes domed bumps that each correspond with one of the detents.

8. The holder of claim 1 wherein the disk separator comb is detachable from an outer shell of the body.

9. The holder of claim 1 wherein the body includes at least one notch extending inward from the bottom opening that is operable as an alignment marker during an automated process.

10. The holder of claim 1 wherein the body includes a cutout extending inward from the top opening, and wherein an axis through the center of the circle passes through the cutout.

11. The holder of claim 1 wherein a bottom of the body is narrower than a top of the body.

12. A method of making a container for transporting media disks comprising:
forming a body comprising a top opening, a bottom opening and a disk separator comb within the body, the disk separator comb including a plurality of rails operable to hold a side edge of the media disks, each rail being shaped to follow the contour of a section of a circle, wherein a portion of the circle extends outside the body;
forming a concave lid operable to cover the top opening, and contain the portion of the circle extending outside the body; and
forming a base cover operable to cover the bottom opening.

13. The method of claim 12 wherein forming the concave lid includes thermoforming the concave lid.

14. The method of claim 12 wherein forming the base cover includes thermoforming the base cover.

15. The method of claim 12 wherein forming the body includes attaching the comb separator to an outer shell.

16. The method of claim 12 wherein forming the body includes injection molding the comb separator and overmolding an outer shell thereon.

17. The method of claim 16 wherein the comb separator comprises polyetheretherketone.

18. The method of claim 12 wherein the body, concave lid and base cover comprise a dissipative material with a resistivity between 10⁵ and 10⁷ ohm/square.

19. The method of claim 12 further comprising fitting the bottom cover into the bottom opening.

20. The method of claim 12 further comprising fitting the top lid into the top opening.
